(19) United States
(12) Patent Application Publication
(10) Pub. No.: US 2015/0068970 A1
(43) Pub. Date: Mar. 12, 2015

(54) Water-Treatment Membrane Module Unit

(71) Applicant: Mitsui Engineering & Shipbuilding Co., Ltd., Tokyo (JP)

(72) Inventors: Takuji Cho, Tokyo (JP); Makoto Naito, Tokyo (JP); Shunsuke Yamazaki, Tokyo (JP)

(73) Assignee: Mitsui Engineering & Shipbuilding Co., Ltd., Tokyo (JP)

(21) Appl. No.: 14/369,819

(22) PCT Filed: Dec. 28, 2012
(86) PCT No.: PCT/JP2012/084105

§ 371 Date: Nov. 24, 2014

(30) Foreign Application Priority Data
Dec. 29, 2011 (JP) 2011-290396

(51) Int. Cl. B01D 63/12

(52) U.S. Cl. CPC B01D 63/12; B01D 2313/105; B01D 2313/125
USPC 210/323.1

(57) ABSTRACT

A water-treatment membrane module with raw-water manifolds connected in common to both end portions of spiral membrane modules and allowing raw water to flow in or out of the spiral membrane modules, in which each of the manifolds comprises a box and cover which may be opened for inspection and access to a treated water manifold in fluid communication with the water collecting pipes.

### TECHNICAL FIELD

The present invention relates to a water-treatment membrane module unit and more particularly a membrane module unit with an improved connection structure between a spiral membrane module and a manifold.

### BACKGROUND ART

There has been a trial for removing microorganisms in ship ballast water through membrane treatment. Particularly in a huge ship such as a tanker, a capacity of a ballast tank is also huge, and a huge amount of ballast water needs to be treated in a short time if the ballast water is subjected to membrane treatment, and a large number of membranes need to be provided in the ship.

Thus, the applicant of the present application proposed a water-treatment membrane module unit having a structure in which a plurality of spiral membrane modules are connected to a manifold constituting a flow passage for raw water (Patent Document 1).

The spiral membrane module has a structure in which an outer periphery of a structural body formed by winding a plurality of envelop-shaped membranes around an outer periphery of a water collecting pipe is covered by an outer cylinder, and by connecting end portions of a plurality of spiral membrane modules to one manifold so that raw water can flow in/out, one water-treatment membrane module unit is constituted.

FIG. 7 illustrates a sectional view of an essential part of this water-treatment membrane module unit. In the figure, reference numeral 100 denotes a spiral membrane module, reference numeral 200 denotes a first manifold connected to one of end portions of the spiral membrane module 100, and reference numeral 300 denotes a second manifold connected to the other end portion of the spiral membrane module 100.

The spiral membrane module 100 has a water collecting pipe 103 having one end closed and only the other end open arranged at a center axis portion, and a plurality of membrane envelopes 102 are wound around an outer periphery of this water collecting pipe 103. A structural body in which the plurality of membrane envelopes 102 are wound around the outer periphery of this water collecting pipe 103 is accommodated in an outer cylinder 101 so that a length direction of the water collecting pipe 103 accords with the length direction of the outer cylinder 101.

The first manifold 200 has a raw water chamber 201 which is common for the plurality of membrane modules 100 therein, and a raw-water inlet 202 through which raw water is introduced and a plurality of attaching opening portions 203 for connecting one end of the outer cylinder 101 of the spiral membrane module 100 are formed on a wall surface.

The second manifold 300 has a cleaning drainage chamber (raw water concentrated liquid) 301 which is common for the plurality of spiral membrane modules 100 therein and a treated water chamber 302 which is partitioned from this cleaning drainage chamber 301 and is common for the plurality of spiral membrane modules 100. The opening end of the water collecting pipe 103 of each of the spiral membrane modules 100 is connected to the treated water chamber 302. On the wall surface, a treated water outlet 303 for discharging the treated water in the treated water chamber 302, a drainage outlet 304 for discharging a drainage in the washing drainage chamber 301, and a plurality of the attaching opening portions 305 for connecting the other end of the outer cylinder 101 of the spiral membrane module 100 are formed.

The first manifold 200, the second manifold 300, and the outer cylinder 101 of the spiral membrane module 100 are fitted via a sealing member such as an O-ring or the like and connected by fixing by an adhesive or by extending a bolt (not shown) across the first manifold 200 and the second manifold 300, for example, and by penetrating the opening end of the water collecting pipe 103 through the wall surface of the treated water chamber 302 of the second manifold 300, the inside of the water collecting pipe 103 is made to communicate with the treated water chamber 302.

According to such water treatment membrane module unit, membrane treatment of a large quantity of the ballast water can be executed at the same time, which is extremely efficient, and various advantages such as space-saving and the like can be obtained.

### CITATION LIST

### Patent Document

Patent Document 1: JP-A-2011-92824

### SUMMARY OF THE INVENTION

### Problem to be Solved by the Invention

The inventor made a keen examination for further performance improvement of this water treatment membrane module unit and has found new problems as follows.

First, since treated water from the spiral membrane module is collected by the water collecting pipe to one of end portions, an independent treated water chamber is provided only on one manifold of the manifolds connected to the both end portions of the spiral membrane module, respectively. As a result, a manifold structure is increased in size and complexity, and moreover, manifolds need to have structures different from each other. Particularly if the water treatment membrane module is to be mounted on a ship and to be used for treatment of the ballast water, in order to effectively use a limited space in the ship, a compact structure is a required condition. Thus, size reduction and simplification of each of the manifolds on the both end portions of the spiral membrane module and the manifold structure that can be used in common are in demand.

Secondly, connection between an end portion side where the water collecting pipe of the spiral membrane module is open and the manifold needs to be in a watertight manner with respect to a bulkhead of the treated water chamber so that the end portion of the water collecting pipe communicates with the treated water chamber in the manifold in addition to watertight connection between the outer cylinder of the spiral membrane module and the manifold. That is because mixing of the raw water (raw water concentrated liquid) in the treated water needs to be avoided. However, since the water collecting pipe is connected so as to penetrate the bulkhead of the treated water chamber inside the manifold, a connected state between the end portion of the water collecting pipe and the bulkhead cannot be directly checked. Thus, easy checking of the connected state (sealed state) of the end portion of the water collecting pipe is in demand.

Thirdly, since the end portion of the water collecting pipe is connected so as to penetrate the wall portion of the treated water chamber formed in the manifold, water-tightness between the end portion of the water collecting pipe and the bulkhead needs to be reliable. However, as described above, in combination with the fact that the connected state between the end portion of the water collecting pipe and the bulkhead cannot be directly checked, a reliable watertight structure cannot be made easily. Thus, connection of the end portion of the water collecting pipe with a reliable watertight structure is in demand.

Thus, the present invention has an object to provide a water-treatment membrane module unit which can simplify the manifold structure to be connected in common to the both end portions of the plurality of spiral membrane modules, respectively, and can realize reliable watertight connection with the water collecting pipe of the spiral membrane module reliably and easily.

Moreover, the other problems of the present invention will be made clear by the following description.

### Means for Solving the Problems

The above problems are solved by each of the following inventions.

1. A water-treatment membrane module unit comprising: a spiral membrane module accommodating a water collecting pipe and a plurality of membrane envelopes wound around an outer periphery of the water collecting pipe in an outer cylinder and forming a raw water flow passage between the adjacent membrane envelopes and manifolds connected to both end portions of the plurality of spiral membrane modules in common and allowing raw water to flow in/out with respect to an outside, respectively, in which flowing in/out of the raw water is made possible between the raw water flow passage of the spiral membrane module and an inside of the manifolds, wherein each of the manifolds is constituted dividably by a first member including a side surface to which the spiral membrane module is connected and a second member including a side surface different from the side surface; and inside at least either one of the manifolds into which an end portion of the water collecting pipe is open, one treated water flow passage formed by a pipeline is provided, and the end portion of the water collecting pipe is connected to the treated water flow passage, respectively.

2. The water-treatment membrane module unit according to 1, wherein the water collecting pipe has only one end portion open; and the water collecting pipe of each of all the spiral membrane modules is opened only to either one of the two manifolds, and the treated water flow passage is provided only inside the one manifold.

3. The water-treatment membrane module unit according to 1, wherein the water collecting pipe has only one end portion open; and the water collecting pipe of each of all the spiral membrane modules branches and is opened to the two manifolds, respectively, and the treated water flow passage is provided inside the two manifolds, respectively.

4. The water-treatment membrane module unit according to 1, wherein the water collecting pipe has both end portions open, respectively; and the water collecting pipe of each of all the spiral membrane modules is opened to the two manifolds, respectively, and the treated water flow passage is provided inside of the two manifolds, respectively.

5. The water-treatment membrane module unit according to any one of 1 to 4, wherein the treated water flow passage is formed by connecting a plurality of pipeline members corresponding to each of the water collecting pipes of the spiral membrane module.

### Effect of the Invention

According to the present invention, the membrane module unit which can simplify the manifold structure connected in common to the both end portions of a plurality of membrane modules, respectively, and can realize reliable watertight connection with the water collecting pipe of the membrane module reliably and easily can be provided.

### BRIEF DESCRIPTION OF THE DRAWINGS

FIG. 1 is a perspective view of one water-treatment membrane module unit.

FIG. 2 is a sectional view of a spiral membrane module.

FIG. 3 is a sectional view of the water-treatment membrane module unit illustrated in FIG. 1.

FIG. 4 is a sectional view illustrating another embodiment of the water-treatment membrane module unit.

FIG. 5 is a sectional view illustrating still another embodiment of the water-treatment membrane module unit.

FIG. 6 is a perspective view of the water-treatment membrane module unit illustrating another mode of a manifold.

FIG. 7 is a sectional view of a prior-art water-treatment membrane unit.

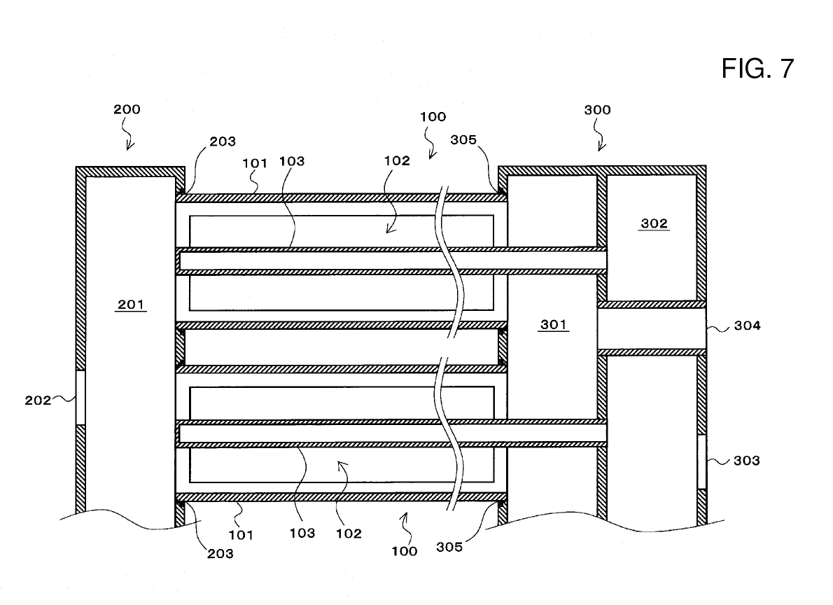

### DESCRIPTION OF EMBODIMENTS

Embodiments of the present invention will be described below.

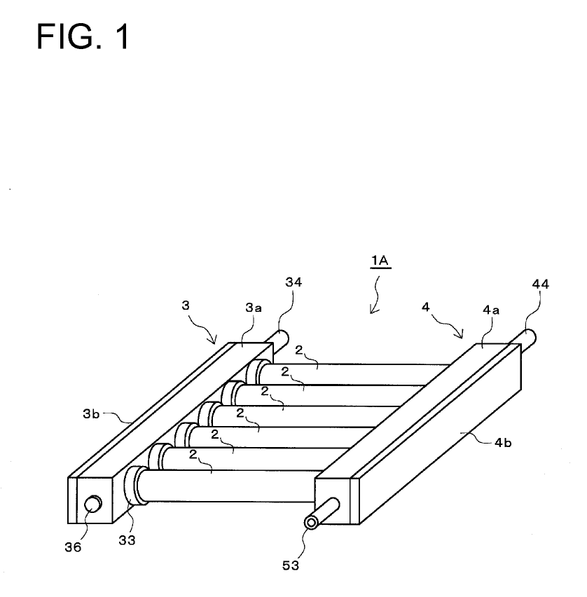

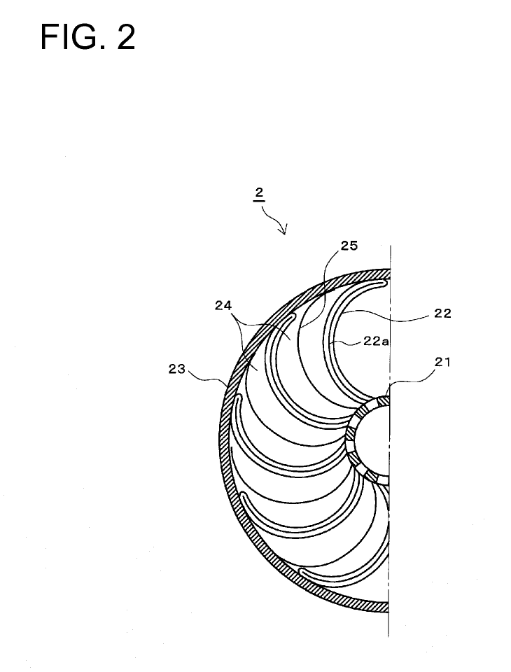

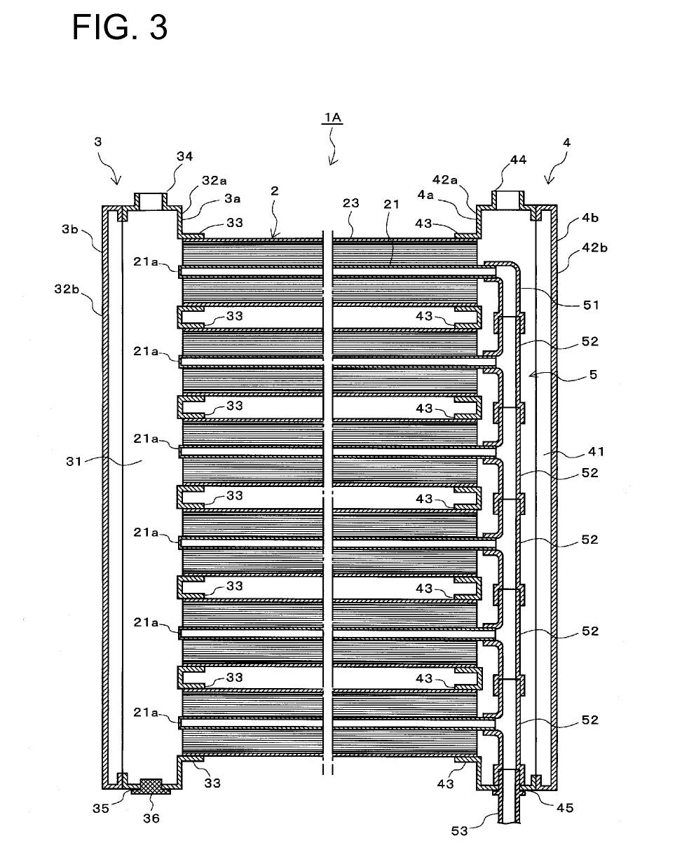

FIG. 1 is a perspective view of one water-treatment membrane module unit, FIG. 2 is a sectional view of a spiral membrane module, and FIG. 3 is a sectional view of the water-treatment membrane module unit illustrated in FIG. 1.

The water-treatment membrane module unit (ballast treatment membrane module unit (hereinafter referred to simply as a unit)) 1A has a plurality of spiral membrane modules (hereinafter referred to simply as a membrane module) 2 juxtaposed in a row and a first manifold 3 and a second manifold 4 connected to both end portions of these membrane modules 2 and in common to these plurality of membrane modules 2.

The membrane module 2 has a water collecting pipe 21 which collects treated water, a large number of membrane envelopes 22 provided in a wound state around an outer periphery of this water collecting pipe 21, and an outer cylinder 23 which covers an outer periphery of a structural body in which the membrane envelope 22 is wound around the outer periphery of this water collecting pipe 21. The outer cylinder 23 is a cylindrical body having a cylindrical shape with both ends open and made of FRP and accommodates the above structural body therein so that a length direction of the water collecting pipe 21 accords with the length direction of the outer cylinder 23.

In each of the membrane envelopes 22, a permeation side spacer 22a which maintains an extended state of the membrane envelope 22 and forms a space for the treated water having permeated an inside of the membrane envelope 22 is disposed, respectively. The inside of the membrane envelope 22 communicates with the inside of the water collecting pipe 21 so that the treated water having permeated the membrane envelope 22 can be transferred to the water collecting pipe 21. The membrane envelopes 22 are radially attached to an outer peripheral surface of the water collecting pipe 21, and since they are wound around the water collecting pipe 21 and wound in high density around the outer periphery of the water collecting pipe 21, they present a substantially columnar shape having the water collecting pipe 21 as an axis as a whole.

Between the adjacent membrane envelope 22, a spacer 25 for preventing close contact between the membrane envelopes 22 with each other and narrowing of a membrane area and for forming a raw water flow passage 24 between the adjacent membrane envelopes 22 between the water collecting pipe 21 and the outer cylinder 23 is inserted.

The water collecting pipe 21 has, as illustrated in FIG. 3, one end closed as a closed end portion 21a and the other end open for discharging the ballast treated water as an open end portion 21b.

It is only necessary that two or more membrane modules 2 are juxtaposed between the first manifold 3 and the second manifold 4. The number is not limited but it is preferably within a range from 3 to 20, more preferably from 4 to 15 and still more preferably from 5 to 10. In this embodiment, 6 membrane modules 2 are juxtaposed in one row.

The one first manifold 3 has a cuboid box shape, and one raw water chamber 31 in common to the plurality of membrane modules 2 is formed inside. A side surface 32a along the longitudinal direction of the first manifold 3 is a connecting surface with the plurality of membrane modules 2, and connection opening portions 33 in the same number as that of the membrane modules 2 each protruding and formed having a cylindrical shape from the side surface 32a are juxtaposed.

On one of end portions of each of the membrane modules 2, the outer cylinder 23 is connected to this connection opening portion 33 in a watertight manner. As a result, the raw water flow passage 24 inside each of the membrane modules 2 communicates with the raw water chamber 31 in the first manifold 3 on one end portion side so that the raw water can flow in/out.

On the one end portion in the longitudinal direction of the first manifold 3, a supply port 34 for supplying the raw water to the raw water chamber 31 is formed, here, and by being connected to a supply pipe, not shown, the raw water can be supplied to the raw water chamber 31.

Moreover, the first manifold 3 is dividably composed of two members, that is, a first member 3a including the side surface 32a to which the membrane module 2 is connected and a second member 3b including a side surface 32b opposite to this side surface 32a. The second member 3b includes the whole side surface 32b and is formed so as to extend along the longitudinal direction of the first manifold 3. The supply port 34 is formed on the first member 3a side.

The first member 3a and the second member 3b are joined while sandwiching a seal member, not shown, and are detachably integrated by an attaching bolt or the like, not shown, so as to constitute the box-shaped first manifold 3. Thus, the first manifold 3 can open the raw water chamber 31 by removing the second member 3b as necessary, so that an internal state such as a connected state with the outer cylinder 23 of each of the membrane modules 2 and a sealed state, for example, can be directly checked.

The other second manifold 4 also presents a cuboid box shape and has the same structure as that of the first manifold 3. Inside it has one raw water chamber 41 formed in common to the plurality of the membrane modules 2. One side surface 42a along the longitudinal direction of the second manifold 4 is a connecting surface with the plurality of membrane modules 2, and connection opening portions 43 in the same number as that of the membrane modules 2 each protruding and formed having a cylindrical shape from the side surface 42a are juxtaposed.

At the other end portion of each of the membrane modules 2, the outer cylinder 23 is connected to this connection opening portion 43 in a watertight manner. As a result, the raw water flow passage 24 inside each of the membrane modules 2 communicates with the raw water chamber 41 in the second manifold 4 similarly to the first manifold 3 also on the other end portion side so that the raw water can flow in/out.

On one end portion in the longitudinal direction of the second manifold 4, a discharge port 44 for discharging the raw water (raw water concentrated liquid after treatment by the membrane module 2) in the raw water chamber 41 is formed, here, and by being connected to a discharge pipe, not shown, the raw water concentrated liquid in the raw water chamber 41 can be discharged.

Moreover, the second manifold 4 is also dividably composed of two members, that is, a first member 4a including the side surface 42a to which the membrane module 2 is connected and a second member 4b including a side surface 42b opposite to this side surface 42a. The second member 4b includes the whole side surface 42b and is formed so as to extend along the longitudinal direction of the second manifold 4. The discharge port 44 is formed on the first member 4a.

The first member 4a and the second member 4b are joined by sandwiching a seal member, not shown, and are detachably integrated by an attaching bolt or the like, not shown, so as to constitute the box-shaped second manifold 4. Thus, the second manifold 4 can open the raw water chamber 41 by removing the second member 4b as necessary, so that an internal state such as a connected state with the outer cylinder 23 of each of the membrane modules 2 and a sealed state and the connected state and the sealed state between the water collecting pipe 21 and a treated water flow passage 5 which will be described later, for example, can be directly checked.

The open end portion 21b of the water collecting pipe 21 in each of the membrane modules 2 is faced in the raw water chamber 41 inside from the connection opening portion 43 of this second manifold 4, respectively. In this raw water chamber 41, the open end portion 21b of each of the water collecting pipes 21 is connected to one common treated water flow passage 5, respectively.

The treated water flow passage 5 is formed by connecting a plurality of pipelines 51 and 52. The pipeline 51 is made of an L-shaped elbow pipe, in which one end is connected to the open end portion 21b of the water collecting pipe 21 in the membrane module 2 arranged on a side the closest to the end portion (upper end side in FIG. 3), while the other end is open toward the longitudinal direction of the second manifold 4.

Moreover, the other pipelines 52 are all made of T-shaped pipes having the same shape and are connected to the water collecting pipes 21 of the membrane modules 2 other than the membrane module 2 connected to the above pipeline 51. A connection port at a center of the pipeline 52 is connected to the open end portion 21b of the water collecting pipe 21 of the membrane module 2, one of connection ports on both ends is connected to the other end of the above pipeline 51, while the other is open toward the longitudinal direction of the second manifold 4 and is connected to the connection port of one of the both ends of the pipeline 52 to be connected to the water collecting pipe 21 of the adjacent membrane module 2.

The treated water flow passage 5 in the second manifold 4 constitutes a flow passage for collecting the treated water taken into the water collecting pipe 21 of each of the membrane modules 2 by connecting the one pipeline 51 to the five pipelines 52. The other end portion in the longitudinal direction opposite to the discharge port 44 of the second manifold 4 has an opening portion 45 formed, and the treated water flow passage 5 is connected to a treated water discharge pipe 53 penetrating and connected to this opening portion 45 in a watertight manner. The opening portion 45 is formed on the first member 4a side of the second manifold 4.

In such a unit 1A, connection between each of the water collecting pipes 21 and the treated water flow passage 5 can be made such that, after the outer cylinder 23 of each of the membrane modules 2 is connected to the connection opening portion 43 formed in the first member 4a of the second manifold 4 through the seal member, respectively, while the second member 4b is removed, the pipelines 51 and 52 are connected to the open end portion 21b of each of the water collecting pipes 21, respectively. Since the connecting work of the pipelines 51 and 52 to each of the water collecting pipes 21 can be performed while directly and visually checking the state, the connected state and the sealed state can be easily checked, and reliable connection and sealing can be performed. After that, by joining the second member 4b, the second manifold 4 having the treated water flow passage 5 inside is completed.

Since each of the water collecting pipes 21 is connected by the pipelines 51 and 52 constituting the treated water flow passage 5 as above, watertight structure more reliable than the prior-art connection structure obtained only by penetration through the wall surface can be realized.

Moreover, though the treated water flow passage 5 is formed only in the second manifold 4, the first manifold 3 and the second manifold 4 can have the completely same structure, and thus, component control can be simplified, and cost reduction can be also realized.

Moreover, since the treated water flow passage 5 is constituted by the pipelines 51 and 52 separately independent of the second manifold 4, it is no longer necessary to form a chamber by partitioning the inside of the second manifold by a bulkhead as in the prior art, by which the size of the manifold can be made compact for that portion.

An opening portion 35 is also formed at the same portion in the first manifold 3 corresponding to the opening portion 45 of the second manifold 4, but since it is not necessary in this embodiment, it is closed by a closing member 36 in a watertight manner.

In this unit 1A, it may be so configured that the raw water is supplied to the second manifold 4. In this case, the discharge port 44 functions as a supply port of the raw water, and the supply port 34 of the first manifold 3 functions as the discharge port of the raw water concentrated liquid.

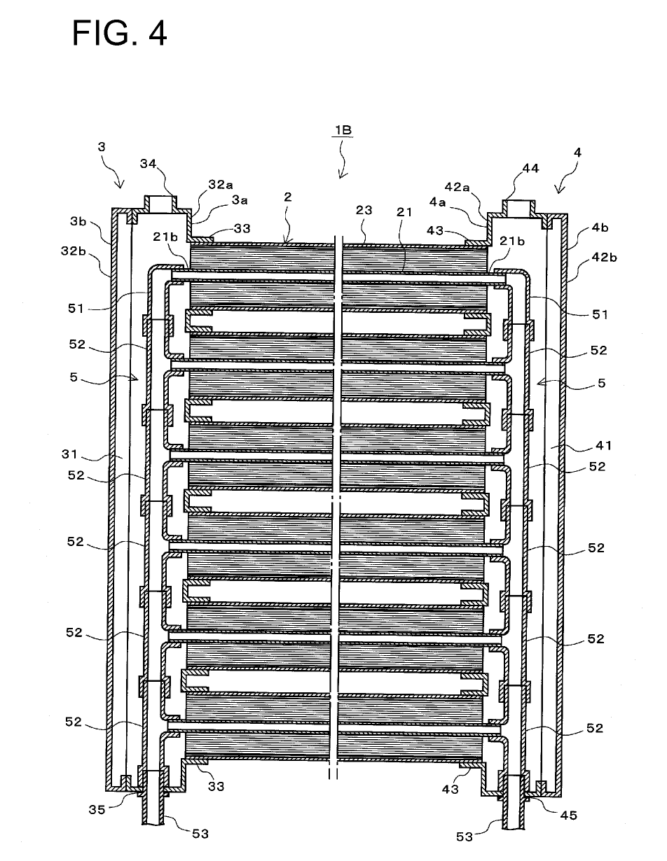

FIG. 4 illustrates another embodiment of the unit. The same reference numerals are given to the portions having the same configurations as in FIG. 3.

In this unit 1B, the water collecting pipe 21 of each of the membrane modules 2 has the open end portions 21b on the both end portions. The open end portion 21b of each of the water collecting pipes 21 is faced with the raw water chambers 31 and 41 in the first manifold 3 and the second manifold 4, respectively, and connected to the treated water flow passage 5 having the same structure in the first manifold 3 and the second manifold 4, respectively. Therefore, in this embodiment, the treated water discharge pipe 53 penetrates and is connected also to the opening portion 36 of the first manifold 3 in a watertight manner, and the unit 1B as a whole has a bilaterally symmetric structure in the illustrated figure.

In this unit 1B, too, after the first member 3a of the first manifold 3 is connected to one end portion of each of the membrane modules 2 and the first member 4a of the second manifold 4 is connected to the other end portion, the treated water flow passage 5 composed of the pipelines 51 and 52, respectively, is connected to the open end portion 21b of each of the water collecting pipes 21 and subsequently, it is only necessary to join the second members 3b and 4b, respectively.

According to this unit 1B, in addition to the same effect as that of the unit 1A, since the both first manifold 3 and the second manifold 4 have the treated water flow passage 5, the treated water can be taken from both of them. Moreover, supply of the raw water and discharge of the raw water concentrated liquid can be performed both from the first manifold 3 and the second manifold 4. Therefore, when a unit assembly is to be constituted by juxtaposing a large number of the units, the treated water discharge pipes 53 need to be juxtaposed so as to be aligned on the same side in the unit 1A illustrated in FIG. 3, but in this unit 1B, the treated water discharge pipe 53 is provided in both of the first manifold 3 and the second manifold 4 and thus, it is not necessary to pay attention so that they are directed in the same way when they are juxtaposed.

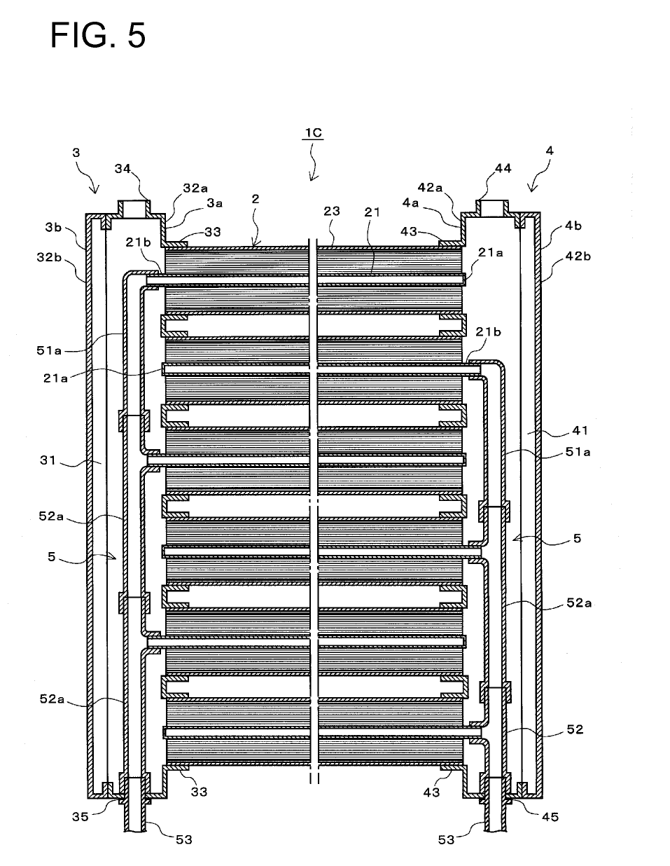

FIG. 5 illustrates still another embodiment of the unit. The same reference numerals are given to the portions of same configuration as those in FIG. 3.

In this unit 1C, the water collecting pipe 21 of each of the membrane modules 2 has only one end portion as the open end portion 21b similarly to FIG. 3, and the open end portion 21b is made to branch to the first manifold 3 side and the second manifold 4 side for each of the membrane modules 2 and arranged. Here, the adjacent membrane modules 2 are arranged alternately on the first manifold 3 side and the second manifold 4 side.

Therefore, in this unit 1C, too, the treated water flow passage 5 connected to the open end portion 21b of the water collecting pipe 21 is provided in each of the first manifold 3 and the second manifold 4, and the treated water discharge pipe 53 penetrates and is connected to the first manifold 3 and the second manifold 4, respectively.

The treated water flow passage 5 in the first manifold 3 is constituted by a pipeline 51a and a pipeline 52a. In a point that the pipeline 51a is made of an L-shaped elbow pipe, and the pipeline 52a is made of a T-shaped pipe, they are equal to the pipelines 51 and 52 illustrated in FIG. 3, but in both of them, a length of one end is formed longer than the other.

The treated water flow passage 5 in the second manifold 4 has the pipeline 51a and the pipeline 52a similar to the above, but only the pipeline 52 of a portion to be connected to the treated water discharge pipe 53 is formed to have the same structure as the pipeline 52 illustrated in FIG. 3.

This unit 1C can also connect each of the membrane modules 2 to the first manifold 3 and the second manifold 4 similarly to the unit 1B.

Moreover, in this unit 1C, in addition to the same effect as that of the unit 1A illustrated in FIG. 3, since the same treated water amount as in the unit 1A can be divided into the treated water flow passage 5 on the first manifold 3 side and the treated water flow passage 5 on the second manifold 4 side and taken out, a flow rate of the treated water flowing through each of the treated water flow passages 5 can be made smaller than that in the unit 1A. As a result, a diameter of the treated water flow passage 5 can be made thinner than that in the unit 1A. Since the diameter of the treated water flow passage 5 is made thinner, capacities of the first manifold 3 and the second manifold 4 can be reduced, whereby the unit can be made more compact.

Moreover, as compared with the unit 1A, since the number of pipelines constituting the treated water flow passage 5 in one manifold becomes smaller, there is also an effect that a connecting work between the water collecting pipe 21 to the pipelines 51a, 52a, and 52 in the manifold and a connecting work between the pipelines can be made more easily.

These units 1A, 1B, and 1C can treat a large amount of the raw water such as the ballast water and the like in a short time by constituting the unit assembly by combining a plurality of units with the same structure, that is, by combining the units 1A with each other, the units 1B with each other or the units 1C with each other.

In each of the assembled units 1A, 1B or 1C, the supply pipe of the raw water and the discharge pipe of the raw water concentrated liquid may be individually connected to the supply port 34 and the discharge port 44, respectively, or other than that, the unit assembly may be configured by connecting the supply port 34 and the discharge port 44 to the opening portions 35 and 45 of the other adjacent unit 1A, 1B or 1C in a watertight manner so that the raw water chambers 31 and 41 communicate with each other among the plurality of units 1A, 1B or 1C. In this case, for the treated water flow passage 5, the T-shaped pipe may be used instead of the pipeline 51 made of the elbow pipe and connected to the treated water flow passage 5 in the other unit 1A, 1B or 1C by a connecting pipeline, not shown, penetrating the opening portions 35 and 45.

In the units 1A, 1B, and 1C described above, the supply port 34 (44) of the raw water and the discharge port 44 (34) of the raw water concentrated liquid are provided on the end portions in the longitudinal direction of the first manifold 3 and the second manifold 4, but they may be provided at portions of the first members 3a and 4a of the first manifold 3 and the second manifold 4, for example.

Moreover, similarly, the treated water discharge pipe 53 may be also provided at the portions of the first members 3a and 4a of the first manifold 3 and the second manifold 4.

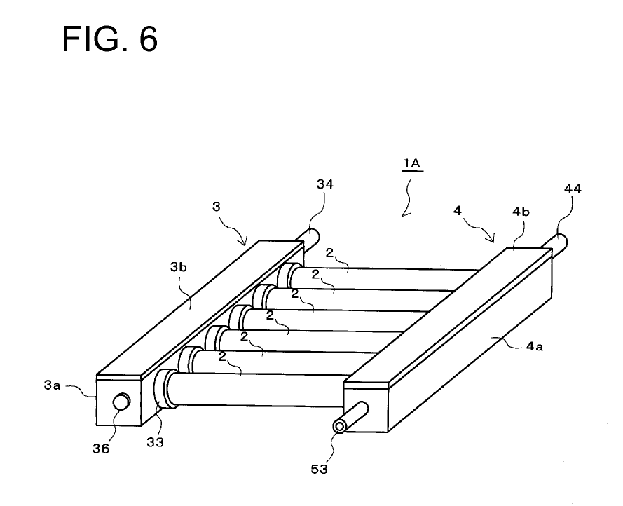

Furthermore, the first manifold 3 and the second manifold 4 described above are both configured capable of being divided into two members, that is, the first members 3a and 4a including the side surfaces 32a and 42a to which the membrane modules 2 are connected, and the second members 3b and 4b including the side surfaces 32b and 42b faced with these side surfaces 32a and 42a, but the second members 3b and 4b may be any as long as they are formed by the side surfaces different from the side surfaces 32a and 42a to which the membrane modules are connected. Therefore, as illustrated in FIG. 6, the second members 3b and 4b may be formed so as to include the side surface adjacent to the side surfaces 32a and 42a to which the membrane module 2 is to be connected.

By forming the first manifold 3 and the second manifold 4 so that each of the second members 3b and 4b is be arranged on the same side (the upper side in FIG. 6, for example) of the unit 1A, a maintenance work can be performed for both the first manifold 3 and the second manifold 4 from the same direction, and workability can be improved.

FIG. 6 illustrates the example using the unit 1A, but the same applies to the other units 1B and 1C.

### REFERENCE SIGNS LIST

1 water-treatment membrane module unit (unit)
2 spiral membrane module (membrane module)
21 water collecting pipe
21a closed end portion
21b open end portion
22 membrane envelope
22a permeation side spacer
23 outer cylinder
24 raw water flow passage
25 spacer
3 first manifold
3a first member
3b second member
31 raw water chamber
32a, 32b side surface
33 connection opening portion
34 supply port
4 second manifold
4a first member
4b second member
41 raw water chamber
42a, 42b side surface
43 connection opening portion
44 supply port
45 opening portion
5 treated water flow passage
51, 52, 51a, 52a pipeline
53 treated water discharge pipe

1. A water-treatment membrane module unit comprising:
a spiral membrane module accommodating a water collecting pipe and a plurality of membrane envelopes wound around an outer periphery of the water collecting pipe in an outer cylinder and forming a raw water flow passage between the adjacent membrane envelopes;
and manifolds connected to both end portions of the plurality of spiral membrane modules in common and allowing raw water to flow in/out with respect to an outside, respectively,
in which flowing in/out of the raw water is made possible between the raw water flow passage of the spiral membrane module and an inside of the manifolds, wherein
each of the manifolds comprises a first member including a first side surface to which the spiral membrane module is connected and a second member including a second side surface different from the first side surface; and
inside at least one of the manifolds into which an end portion of the water collecting pipe is open, a treated water flow passage formed by a pipeline is provided, and the end portion of the water collecting pipe is connected to the treated water flow passage.

2. The water-treatment membrane module unit according to claim 1, wherein
the water collecting pipe has only one end portion open; and
the water collecting pipe of each of all the spiral membrane modules is opened to one of the two manifolds, and the treated water flow passage is provided only inside the one manifold.

3. The water-treatment membrane module unit according to claim 1, wherein
the water collecting pipe has only one end portion open; and
the water collecting pipe of each of all the spiral membrane modules branches and is opened to the two manifolds, respectively, and the treated water flow passage is provided inside the two manifolds, respectively.

4. The water-treatment membrane module unit according to claim 1, wherein
the water collecting pipe has both end portions open, respectively; and
the water collecting pipe of each of all the spiral membrane modules is opened to the two manifolds, respectively, and the treated water flow passage is provided inside of the two manifolds, respectively.

5. The water-treatment membrane module unit according to any one of claims 1 to 4, wherein
the treated water flow passage is formed by connecting a plurality of pipeline members corresponding to each of the water —collecting pipes of the spiral membrane module.
